(19) United States
(12) Patent Application Publication
(10) Pub. No.: US 2023/0003502 A1
(43) Pub. Date: Jan. 5, 2023

(54) SYSTEM AND METHOD FOR MEASURING A DEFORMATION OF A STRUCTURE OF AN AIRCRAFT

(71) Applicant: LEONARDO S.P.A., Roma (IT)

(72) Inventor: Michele IANNONE, Torre Annunziata (Napoli) (IT)

(21) Appl. No.: 17/781,399

(22) PCT Filed: Dec. 3, 2020
(86) PCT No.: PCT/IB2020/061421

§ 371 Date: Jun. 1, 2022

(30) Foreign Application Priority Data
Dec. 5, 2019 (IT) 102019000023088

(51) Int. Cl. G01B 7/16; G01M 5/00

(52) U.S. Cl. CPC G01B 7/18; G01M 5/0016; G01M 5/0041

(57) ABSTRACT

A system for measuring a deformation of a structure configured to be installed on an aircraft includes deformation sensor means configured to be associated with the structure and to assume an electrical resistance value indicative of the deformation of the structure and having two short-circuited electrical connection terminals to recreate a closed circuit, magnetic field excitation means having a laser generator and configured to generate a magnetic field concatenated with the closed circuit to generate an induced current, electromagnetic radiation, transmission means having an antenna and configured to emit an electromagnetic radiation, value of the electromagnetic radiation being a function of the electrical resistance of the deformation sensor means, electromagnetic radiation receiving means having an antenna and configured to receive the electromagnetic radiation transmitted by the electromagnetic radiation transmission means, and control means for determining the deformation of the structure as a function of the value of electromagnetic radiation received.

### TECHNICAL FIELD

The present invention generally lies within the field of measuring deformations of a structure; in particular, the invention relates to a system for measuring a deformation of a structure arranged to be installed on an aircraft and a corresponding method for measuring a deformation of a structure arranged to be installed on an aircraft.

### PRIOR ART

The simplest known extensometers work on the principle of varying their own electrical resistance value as a function of their deformation.

However, there are also more complex types of extensometers based on piezoresistive or magnetostrictive properties, as described for example in U.S. Pat. No. 7,913,569 B2 and EP 0329479 B1.

Extensometers of this kind are usually used to detect and measure the deformation of a structure. In particular, as illustrated by way of example in FIG. 1, these extensometers 3 are coupled to the structure 5 of which the deformation is to be measured and have two cables 7 emerging from this structure 5, to which cables the equipment 9 necessary for powering the extensometer has to be connected in order to be able to measure its resistance and consequently derive the deformation of the structure therefrom. This equipment 9 may be ohmmeters, for example.

This solution is particularly inconvenient and impractical.

In cases in which a deformation measurement is required at a plurality of points of a structure, for example in laboratory tests, flight tests and when monitoring the health of the structure (“structural health monitoring”), the use of a plurality of extensometers arranged at the various points of the structure is required. Each of these extensometers needs to be connected via two cables to equipment necessary for powering the extensometer in order to be able to measure its resistance and consequently derive the deformation of the structure therefrom. A complex and heavy set-up is therefore required to be able to measure the deformation of the structure at various points, since each time it will be necessary to move said equipment between the various extensometers and work will be required to connect said equipment to each extensometer.

For example, U.S. Pat. No. 5,433,115 A describes an apparatus for contactless interrogation of a sensor, U.S. Pat. No. 5,288,995 A describes an apparatus for electrical measurements, and EP 2 409 916 A2 describes a deformation sensor for measuring loads. Nevertheless, the aforementioned problems of inconvenience and lack of practicality remain unresolved.

### SUMMARY OF THE INVENTION

An object of the present invention is therefore to provide a system and a method for measuring a deformation of a structure arranged to be installed on an aircraft which allow the convenience and practicality of using systems for measuring a deformation of a structure of an aircraft to be improved. This system and this method for measuring a deformation of a structure arranged to be installed on an aircraft require a simpler set-up even when measuring a deformation at various points of said structure.

The aforesaid and other aims and advantages are achieved, according to one aspect of the invention, by a system for measuring a deformation of a structure arranged to be installed on an aircraft and a method for measuring a deformation of a structure arranged to be installed on an aircraft that have the features defined in the respective independent claims. Preferred embodiments of the invention are defined in the dependent claims, the content of which is to be understood as an integral part of the present description.

### BRIEF DESCRIPTION OF THE DRAWINGS

The functional and structural features of some preferred embodiments of a system and a method for measuring a deformation of a structure of an aircraft according to the invention will now be described. Reference is made to the accompanying drawings, in which:

FIG. 1 is a system for measuring a deformation of a structure according to the prior art; and

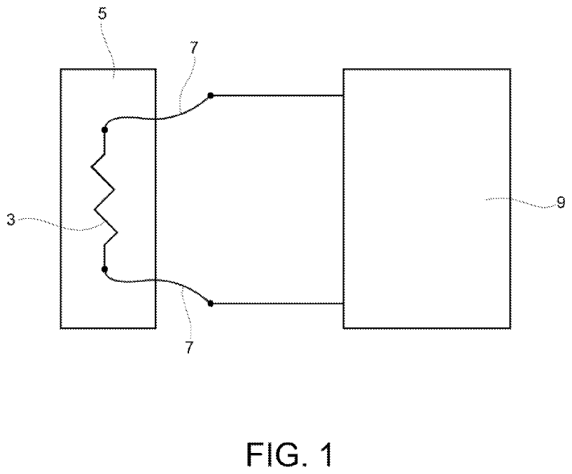

FIG. 2 is a system for measuring a deformation of a structure of an aircraft according to the invention.

### DETAILED DESCRIPTION

Before describing in detail a plurality of embodiments of the invention, it should be clarified that the invention is not limited in its application to the design details and configuration of the components presented in the following description or illustrated in the drawings. The invention is able to assume other embodiments and to be implemented or constructed in practice in different ways. It should also be understood that the phraseology and terminology have a descriptive purpose and should not be construed as limiting. The use of “include” and “comprise” and their variations are to be understood as encompassing the elements set out below and their equivalents, as well as additional elements and the equivalents thereof.

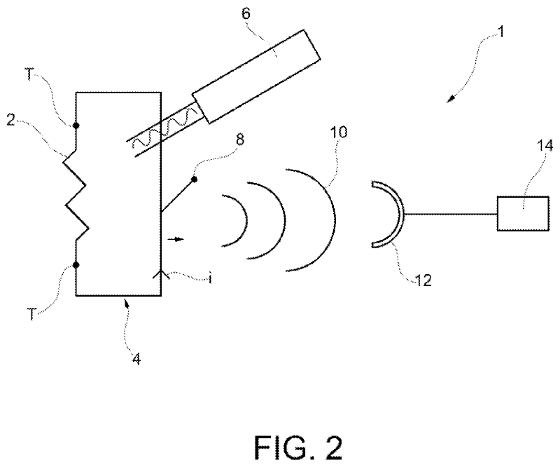

With initial reference to FIG. 2, a system 1 for measuring a deformation of a structure arranged to be installed on an aircraft comprises deformation sensor means 2 including two electrical connection terminals T. The deformation sensor means 2 are arranged to be associated with said structure and to assume an electrical resistance value between said electrical connection terminals T. The resistance value is indicative of the deformation of said structure. The electrical connection terminals T of the deformation sensor means 2 are short-circuited so as to recreate a closed circuit 4.

The system 1 for measuring a deformation of a structure arranged to be installed on an aircraft also comprises magnetic field excitation means 6 arranged to generate a magnetic field concatenated with this closed circuit 4, so that an induced current i is generated in the closed circuit 4. These magnetic field excitation means 6 include a laser generator arranged to emit a laser signal having amplitude that varies over time according to a frequency.

In other words, the magnetic field excitation means 6 may be a system or a device or an apparatus for generating lasers.

Moreover, the system 1 for measuring a deformation of a structure arranged to be installed on an aircraft comprises electromagnetic radiation transmission means 8 included in the closed circuit 4.

These electromagnetic radiation transmission means 8 include an antenna. In other words, the electromagnetic radiation transmission means 8 may be a circuit or a system or an apparatus for electromagnetic radiation transmission that includes an antenna or may directly be an antenna associated with the closed circuit.

The electromagnetic radiation transmission means 8 are arranged to emit an electromagnetic radiation 10 generated by the induced current i which flows in the closed circuit 4. The value of the electromagnetic radiation is a function of the value of electrical resistance assumed by the deformation sensor means 2 that is indicative of the deformation of this structure. In particular, the value of the induced current i is inversely proportional to the value of the electrical resistance assumed by the deformation sensor means 2, and the value of the magnetic radiation 10 is proportional to the value of the induced current i. The value of the magnetic radiation will therefore be linked to the value of the electrical resistance assumed by the deformation sensor means 2.

Moreover, the system 1 for measuring a deformation of a structure arranged to be installed on an aircraft comprises electromagnetic radiation receiving means 12 arranged to receive the electromagnetic radiation 10 transmitted by the antenna of said electromagnetic radiation transmission means 8, and control means 14 arranged to determine the deformation of the structure as a function of the value of electromagnetic radiation received by the electromagnetic radiation receiving means 14.

The electromagnetic radiation receiving means 12 also include an antenna. In other words, the electromagnetic radiation receiving means 12 may be a circuit or a system or an apparatus for receiving electromagnetic radiation that includes an antenna or may directly be an antenna.

By virtue of the antennas of the electromagnetic radiation receiving means and the electromagnetic radiation transmission means, the system advantageously also makes it possible to be able to measure deformation values without the need for the electromagnetic radiation transmission means 8 and the electromagnetic radiation receiving means 12 of the system to be substantially in contact with one another.

The deformation sensor means 2 may preferably include at least one extensometer. In other words, the deformation sensor means 2 may be a circuit or a system or an apparatus including the extensometer or may directly be an extensometer sensor.

The system for measuring a deformation of a structure arranged to be installed on an aircraft may clearly also include a plurality of said deformation sensor means 2 included in respective closed circuits 4. Each closed circuit may clearly include respective electromagnetic radiation transmission means.

Advantageously, since the magnetic field excitation means 6 include a laser generator, it would be possible to induce all of the currents in the various closed circuits 4 present by means of this single laser generator.

In other embodiments, the magnetic field excitation means 6 may preferably also include a magnetic induction coil arranged to generate a magnetic field having an amplitude which varies over time according to a frequency.

For example, the laser signal generated by the laser generator or the magnetic field generated by the coil may have a sinusoidal curve. The fact that the laser signal or the magnetic field have a curve that varies over time is necessary so that an electromotive force is generated in the closed circuit and that an induced correct is consequently generated that flows in the closed circuit. This will also be clarified in the following part of the description by means of using formulae.

In one embodiment, the magnetic field excitation means 6, the electromagnetic radiation receiving means 12 and the control means 14 may be remote with respect to said structure of the aircraft. In other words, the magnetic field excitation means 6, the electromagnetic radiation receiving means 12 and the control means 14 may not be installed on the structure, but instead may be comprised in devices external to the structure, as shown for example in FIG. 2.

By way of example, the electromagnetic radiation receiving means 12 and the control means 14 being remote with respect to said structure of the aircraft is understood to mean, for example, the case in which the deformations of the structure are measured in laboratory tests, in which the structure is tested individually and is not installed on the aircraft, or the case in which the deformations of the structure are measured on the ground, when the structure is installed on a complete vehicle.

In different embodiments, the electromagnetic radiation receiving means 12 may be installed remotely with respect to the structure but may be installed on the aircraft comprising this structure. This may be, for example, the case in which measurements of the deformation of the structure are carried out in a flight condition of the aircraft.

For example, the structure of the vehicle of which the deformation is intended to be measured may be a wing, a fuselage or an empennage.

The present invention also relates to a method for measuring a deformation of a structure arranged to be installed on an aircraft.

This method comprises the step of associating deformation sensor means 2, which are arranged to assume an electrical resistance value indicative of the deformation of this structure and include two electrical connection terminals T, with a structure of the aircraft.

The method also comprises the steps of short-circuiting the electrical connection terminals T of said deformation sensor means 2 so as to recreate a closed circuit 4, and generating, by means of a laser generator arranged to emit a laser signal having amplitude that varies over time according to a frequency, a magnetic field concatenated in said closed circuit 4, so that an induced current i is generated in this closed circuit 4.

The method also comprises the step of emitting, by means of an antenna of electromagnetic radiation transmission means 8, an electromagnetic radiation 10 generated by the induced current i in this closed circuit 4, the value of the electromagnetic radiation being a function of the value of electrical resistance assumed by the deformation sensor means that is indicative of the deformation of this structure, the step of receiving, by means of an antenna of electromagnetic radiation receiving means 12, the electromagnetic radiation transmitted by the antenna of the electromagnetic radiation transmission means 8, and the step of determining the deformation of the structure as a function of the value of electromagnetic radiation received.

The step of determining the deformation of the structure as a function of the value of electromagnetic radiation received may preferably comprise determining the electrical resistance value of the deformation sensor means 2 from the intensity of the received electromagnetic radiation 10 correlated with the current i induced in the circuit due to an induced electromotive force, correlated with the excitation received according to the Faraday-Neumann law.

The Faraday-Neumann law is a law of physics which describes the phenomenon of electromagnetic induction that occurs when the flux of the magnetic field across the surface delimited by an electrical circuit is variable over time. The law requires that an induced electromotive force equal to the opposite of the temporal variation of the flux be generated in the circuit.

The induced electromotive force EMF will be equal to the speed at which the concatenated magnetic field varies, and will have a negative value when the magnetic field increases and a positive value when the magnetic field decreases.

The formula for calculating the electromotive force EMF is:

$$\frac{\partial {Φ}_{B}}{\partial t} = E M F$$

where ∂Φ_{B} is the variation in the concatenated magnetic field and ∂t is a time interval.

In view of the above formula, the induced electromotive force EMF is produced by the derivative with respect to the time of the concatenated magnetic flux.

With knowledge of the variation values of the magnetic field and of the time interval associated with the magnetic field generated by the magnetic field excitation means, it is also possible, using Ohm's first law, to calculate the intensity of the induced current in the closed circuit:

$$i = \frac{E M F}{R} = \frac{1}{R} \frac{\partial {Φ}_{B}}{\partial t}$$

From this formula, with knowledge of the electromotive force EMF and the induced current, it is possible to obtain the resistance of the closed circuit, i.e. the resistance of said deformation sensor means.

$$R = \frac{E M F}{i} = \frac{\frac{\partial {Φ}_{B}}{\partial t}}{i}$$

Considering a neutral deformation condition of the structure, in which the structure with which the deformation sensor means are associated is not deformed, it is possible to determine a neutral value of resistance associated with the value of electromagnetic radiation received.

When the structure is subsequently deformed, the resistance of the deformation sensor means will undergo a certain variation, proportional to the value of the deformation undergone by the structure. The induced current in the closed circuit will also undergo a variation correlated with the variation of the resistance of the deformation sensor means. Consequently, the electromagnetic radiation transmitted by the electromagnetic radiation transmission means and received by the electromagnetic radiation receiving means will also undergo a variation correlated with the variation of the induced current in the closed circuit.

Therefore, by observing the variation in the value of the electromagnetic radiation received in a deformed structure condition, with respect to the value of the electromagnetic radiation received in the neutral deformation condition of the structure, it will be possible to derive the value of deformation to which the structure is subjected.

The consequent advantage is therefore that of having provided a system and a method for measuring a deformation of a structure of an aircraft which allow the convenience and practicality of using systems for measuring a deformation of a structure of an aircraft to be improved.

A further advantage consists in having provided a system which makes it possible to measure deformation values of a structure by means of suitable deformation sensor means associated therewith, by means of a single magnetic field excitation means.

Various aspects and embodiments of a system and a method for measuring a deformation of a structure of an aircraft according to the invention have been described. It is understood that each embodiment may be combined with any other embodiment. Furthermore, the invention is not limited to the described embodiments, but may be varied within the scope defined by the appended claims.

1. A system for measuring a deformation of a structure arranged configured to be installed on an aircraft, the system comprising:
deformation sensor means including two electrical connection terminals, the deformation sensor means being configured to be associated with said structure and to assume, between said two electrical connection terminals, an electrical resistance value indicative of the deformation of said structure, wherein the two electrical connection terminals of said deformation sensor means are short-circuited so as to recreate a closed circuit;
magnetic field excitation means configured to generate a magnetic field concatenated with said closed circuit, so that an induced current is generated in the closed circuit, wherein said magnetic field excitation means include a laser generator configured to emit a laser signal having amplitude that varies over time according to a frequency;
electromagnetic radiation transmission means included in said closed circuit, wherein said electromagnetic radiation transmission means include an antenna and are configured to emit an electromagnetic radiation generated by the induced current in said closed circuit, a value of the electromagnetic radiation being a function of the electrical resistance value assumed by the deformation sensor means indicative of the deformation of the structure;
electromagnetic radiation receiving means including an antenna and configured to receive the electromagnetic radiation transmitted by the antenna of said electromagnetic radiation transmission means-; and
control means configured to determine the deformation of the structure as a function of the value of the electromagnetic radiation received by the electromagnetic radiation receiving means.

2. The system of claim 1, wherein said deformation sensor means include at least one extensometer.

3. The system of claim 1, wherein the structure of the aircraft is at least one of a wing, a fuselage, an empennage.

4. The system of claim 1, wherein the magnetic field excitation means, the electromagnetic radiation receiving means and the control means are remote with respect to said structure.

5. The system of claim 4, wherein the structure is installed on the aircraft and the magnetic field excitation means, the electromagnetic radiation receiving means and the control means are installed on the aircraft.

6. A method for measuring a deformation of a structure configured to be installed on an aircraft, the method comprising:
associating deformation sensor means with said structure, the deformation sensor means being configured to assume an electrical resistance value indicative of the deformation of the structure and including two electrical connection terminals;
short-circuiting the two electrical connection terminals of said deformation sensor means so as to recreate a closed circuit;
generating, by of a laser generator configured to emit a laser signal having amplitude that varies over time according to a frequency, a magnetic field concatenated in said closed circuit, so that an induced current is generated in the closed circuit;
emitting, by an antenna of electromagnetic radiation transmission means, an electromagnetic radiation generated by the induced current in the closed circuit, a value of the electromagnetic radiation being a function of the electrical resistance value assumed by the deformation sensor means; the electrical resistance value being indicative of the deformation of the structure;
receiving, by an antenna of electromagnetic radiation receiving means, the electromagnetic radiation transmitted by the antenna of said electromagnetic radiation transmission means; and
determining the deformation of the structure as a function of the value of the electromagnetic radiation received.

7. The method of claim 6, wherein determining the deformation of the structure as a function of the value of the electromagnetic radiation received comprises:
in a neutral deformation condition of the structure, determining the value of the electromagnetic radiation received;
in a deformed structure condition, determining a variation of a current value of the electromagnetic radiation received, with respect to the value of the electromagnetic radiation received in the neutral deformation condition of the structure; and
determining the deformation of the structure as a function of the determined variation.
